(19) United States
(12) Patent Application Publication
(10) Pub. No.: US 2016/0321238 A1
(43) Pub. Date: Nov. 3, 2016

(54) ELECTRONIC DEVICE, METHOD AND STORAGE MEDIUM

(71) Applicant: KABUSHIKI KAISHA TOSHIBA, Tokyo (JP)

(72) Inventors: Yukihiro KURITA, Kokubunji Tokyo (JP); Toshiyuki YAMAGAMI, Fussa Tokyo (JP); Tatsuo YAMAGUCHI, Kunitachi Tokyo (JP); Yuki KANBE, Ome Tokyo (JP); Shogo IKEDA, Tachikawa Tokyo (JP)

(21) Appl. No.: 14/874,206

(22) Filed: Oct. 2, 2015

Related U.S. Application Data
(60) Provisional application No. 62/154,225, filed on Apr. 29, 2015.

(51) Int. Cl. G06F 17/27; G06K 9/00; G06F 17/22; G10L 25/51; G06F 3/16; G06F 3/0488

(52) U.S. Cl. CPC G06F 17/276; G06F 3/167; G06F 3/04883; G06F 17/2211; G10L 25/51; G06K 9/00402

(57) ABSTRACT

An electronic device includes a microphone generating audio data, a screen detecting a stroke input made on a surface thereof and displaying the stroke, a memory that stores different handwritings, and a processor. The processor is configured to search the memory for first and second handwriting candidates in response to a handwritten stroke made on the screen, determine whether a first or second character string of the first or second handwriting candidate matches a third character string of a word in the audio data, and display the first handwriting candidate at a first position and the second handwriting candidate at a second position on the screen. The second position is arranged closer to an input position of the handwritten stroke on the surface than the first position, if the first character string does not match the third character string and the second character string matches the third character string.

### CROSS-REFERENCE TO RELATED APPLICATION

This application is based upon and claims the benefit of priority from the U.S. Provisional Patent Application No. 62/154,225, filed Apr. 29, 2015, the entire contents of which are incorporated herein by reference.

### FIELD

Embodiments described herein relate to an electronic device, a method and a storage medium.

### BACKGROUND

Recently, various devices such as tablets, PDAs and smartphones have been developed. Most of these types of electronic devices comprise touchscreen displays to facilitate user input operations. In addition, electronic devices capable of handling handwritten character strings have also been recently developed. A user can easily take notes by using such an electronic device that supports handwriting input.

However, technology that facilitates handwriting input is not fully developed in the related art.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view showing an appearance of an electronic device of one of embodiments.

FIG. 2 is an exemplary illustration showing combined operations of the electronic device shown in FIG. 1 and an external device.

FIG. 3 is an illustration showing an example of a handwritten document which is handwritten on a touchscreen display of the electronic device shown in FIG. 1.

FIG. 4 is an exemplary diagram that illustrates time series information produced by the electronic device shown in FIG. 1.

FIG. 5 is an exemplary block diagram showing a system configuration of the electronic device shown in FIG. 1.

FIG. 6 is an exemplary block diagram showing a functional configuration of a handwriting note application program executed by the electronic device shown in FIG. 1.

FIG. 7 is an exemplary illustration showing a user interface (edit screen) displayed by the electronic device shown in FIG. 1.

FIG. 8 is an exemplary illustration showing a handwriting candidate list box displayed in an edit view area in the edit screen.

FIG. 9 is an exemplary illustration showing the handwriting candidate list box enlarged in size by tapping a “show more” button.

FIG. 10 is another exemplary illustration showing the handwriting candidate list box displayed in the edit view area in the edit screen.

FIG. 11 is an exemplary illustration showing a situation in which a tentative stroke is completed by a handwriting candidate selected in the handwriting candidate list box shown in FIG. 10.

FIG. 12 is an exemplary flowchart showing procedures of autocomplete processing executed by the electronic device shown in FIG. 1.

FIG. 13 is an exemplary flowchart showing procedures of handwriting candidate priority control processing executed by the electronic device shown in FIG. 1.

FIG. 14 is an exemplary flowchart showing procedures of handwriting candidate list box display processing executed by the electronic device shown in FIG. 1.

FIG. 15 is an exemplary illustration showing connection between electronic devices (terminals) using a handwriting sharing service.

FIG. 16 is an exemplary illustration showing processing of sharing a single canvas by the terminals.

FIG. 17 is an exemplary table showing the relationship between strokes on a shared screen (canvas) and authors.

FIG. 18 is an exemplary diagram illustrating the data flow between plural electronic devices.

FIG. 19 is an exemplary diagram illustrating a modified example of the autocomplete processing executed by the electronic device shown in FIG. 1.

### DETAILED DESCRIPTION

Various embodiments will be described hereinafter with reference to the accompanying drawings.

According to an embodiment, an electronic device includes a microphone capable of generating audio data based on sounds received therethrough, a screen capable of detecting a stroke input made on a surface thereof and displaying the stroke, a memory that stores different handwritings, and a hardware processor. The hardware processor is configured to search the memory for a first handwriting candidate and a second handwriting candidate in response to a handwritten stroke made on a surface of the screen, determine whether a first character string of the first handwriting candidate or a second character string of the second handwriting candidate matches a third character string of a word contained in the audio data, and display the first handwriting candidate at a first position and the second handwriting candidate at a second position on the screen. The second position is arranged closer to an input position of the handwritten stroke on the surface than the first position, if the first character string does not match the third character string and the second character string matches the third character string.

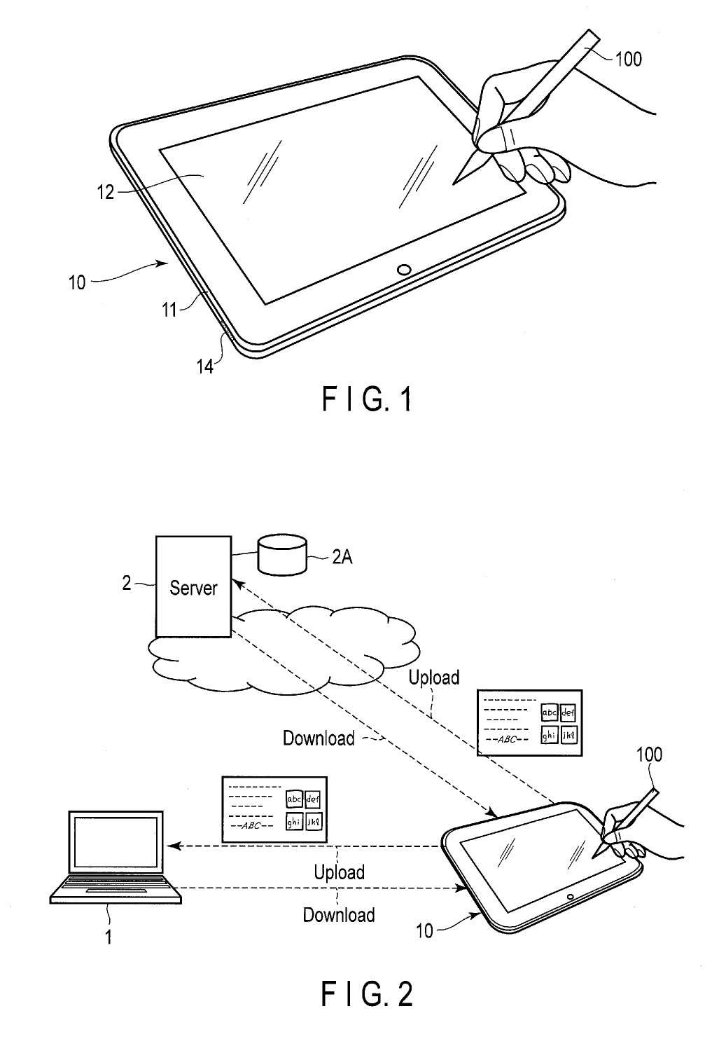

FIG. 1 is a perspective view showing an appearance of the electronic device of one of the embodiments. The electronic device is, for example, a pen-based portable electronic device which enables handwriting input using a pen (stylus) or finger. The electronic device can be implemented as a tablet computer, a notebook-type personal computer, a smartphone, a PDA or the like. Implementation of the electronic device as a tablet computer 10 is hereinafter assumed. The tablet computer 10 is a portable electronic device called a tablet or a slate computer. The tablet computer 10 comprises a body 11 and a touchscreen display 12 as shown in FIG. 1. The body 11 comprises a housing shaped as a thin box. The touchscreen display 12 is attached to overlap a front surface of the body 11. A microphone (not shown in FIG. 1) is attached to an upper side surface portion of the body 11. In addition, speakers 14 are arranged on both side surface portions of the body 11.

A flat panel display and a sensor are built in the touchscreen display 12. A sensor is configured to detect a contact position of the pen or finger on the screen of the flat panel display. The flat panel display may be, for example, a liquid crystal display device (LCD). Examples for the sensor include a capacitive touch panel, an electromagnetic induction-type digitizer, etc. It is hereinafter assumed that the capacitive touch panel is built in the touchscreen display 12.

The touch panel is arranged on, for example, a screen of the flat panel display. The touchscreen display 12 can detect not only a touch operation on the screen using a finger, but also a touch operation on the screen using a pen or stylus 100.

The user can execute the handwriting input operation on the touchscreen display 12, by using an external object (pen 100 or finger). During the handwriting input operation, a locus of movement of the external object (pen 100 or finger) is formed on the screen, i.e., handwriting is drawn in real time. The locus of movement of the external object formed while the external object is in contact with the screen corresponds to one stroke. A set of multiple strokes corresponding to a handwritten letter or a handwritten figure, constitutes a handwritten document.

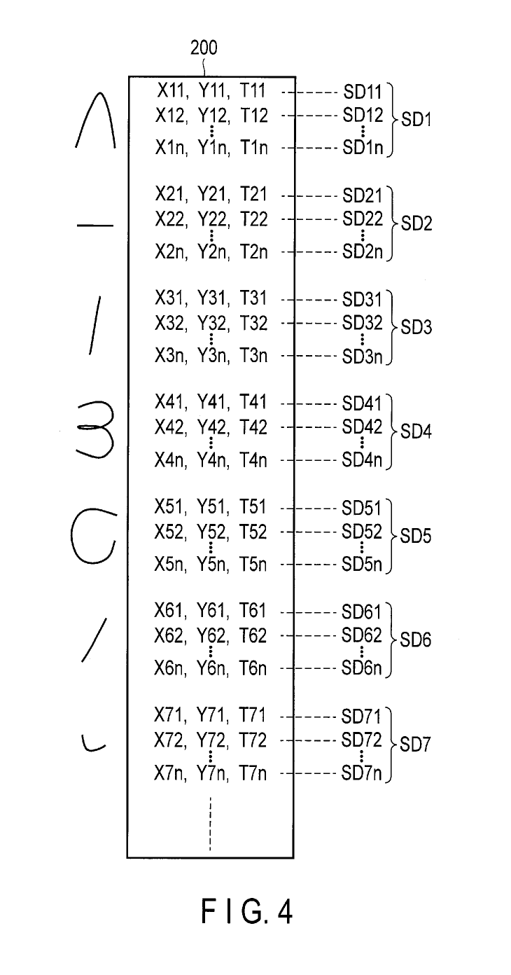

In the present embodiment, the handwritten document is stored in a storage medium not as image data, but as time-series information indicating a coordinate string of the locus of each stroke and a relationship among the strokes. Details of the time series information will be explained later with reference to FIG. 4, but the time-series information includes plural stroke data corresponding to the plural strokes, respectively. Each of the stroke data corresponds to a certain stroke and includes coordinate data sequence (time-series coordinates) corresponding to each point on the stroke. The stroke data are arranged according to a sequence that corresponds to an order in which the strokes are handwritten, i.e., a stroke order.

The tablet computer 10 can read existing arbitrary time-series information (handwritten document information) from the storage medium and display the handwriting (plural strokes) indicated by the handwritten document information on the screen. The tablet computer 10 further has an edit function. The edit function can delete or move an arbitrary stroke, an arbitrary handwritten character, or the like in a currently displayed handwritten document by an “eraser” tool, a “select range” tool, and other various tools. The edit function further includes a function of canceling a history of several handwriting operations.

The tablet computer 10 further has an autocomplete (stroke recommendation) function. The autocomplete function is a function of assisting the user's handwriting input operation to enable multiple character strings to be easily input as a result of the handwriting.

FIG. 2 shows an example of communication between the tablet computer 10 and an external device. The tablet computer 10 can communicate with a personal computer 1 or a cloud. Specifically, the tablet computer 10 comprises a wireless communication device such as a wireless LAN, and can execute wireless communication with the personal computer 1. Furthermore, the tablet computer 10 can also communicate with a server 2 accessible through the Internet. The server 2 may be a server that provides on-line storage services or other various cloud computing services.

The personal computer 1 comprises a storage device such as a hard disk drive (HDD). The tablet computer 10 can transmit (upload) time-series information (handwritten document) to the personal computer 1 via a network and record the time-series information in the HDD of the personal computer 1.

This enables the tablet computer 10 to handle a large number of time-series information (handwritten document) or a large amount of time-series information (handwritten document) even when the capacity of the storage in the tablet computer 10 is small.

Furthermore, the tablet computer 10 can read at least one arbitrary handwritten document recorded on the HDD of the personal computer 1 and downloaded to the tablet computer 10. The tablet computer 10 can display each of strokes indicated by the read handwritten document on the screen of the touchscreen display 12 of the tablet computer 10.

Furthermore, a destination with which the tablet computer 10 communicates may not be the personal computer 1, but the server 2 on a cloud that provides storage services, as explained above. The tablet computer 10 can transmit (upload) the handwritten document to the server 2 via a network and record the handwritten document in the storage device 2A of the server 2. Furthermore, the tablet computer 10 can read an arbitrary handwritten document recorded in the storage device 2A of the server 2 and downloaded to the tablet computer 10. The tablet computer 10 can display each of strokes indicated by the read handwritten document on the screen of the touchscreen display 12 of the tablet computer 10.

As described above, in the present embodiment, the storage medium in which the handwritten document is stored may be any one of the storage device in the tablet computer 10, the storage device in the personal computer 1, and the storage device of the server 2.

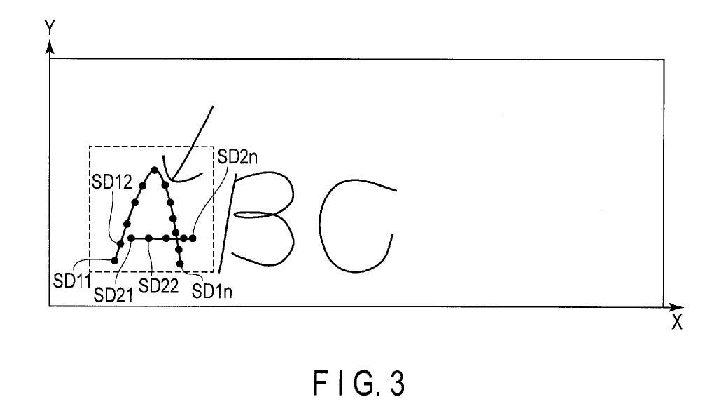

Next, a relationship between strokes (characters, marks, or figures (diagrams), tables, etc.) handwritten by the user and the handwritten document will be explained with reference to FIG. 3 and FIG. 4. FIG. 3 shows an example of a handwritten character string handwritten on the touchscreen display 12 with a pen 100, for example.

In a handwritten document, another character, figure, etc., are often handwritten on an already handwritten character, figure, etc. In FIG. 3, it is assumed that a handwritten character string “ABC” is handwritten in the order of “A”, “B”, and “C” and then a handwritten arrow is handwritten at a position very close to the handwritten letter “A”.

The handwritten letter “A” is represented by two strokes (a “̂”-shaped locus and a “-”-shaped locus) handwritten with the pen 100, etc. The “̂”-shaped locus which is first handwritten with the pen 100 is sampled in real time at equal time intervals, for example, and time-series coordinates SD11, SD12, . . . , SD1n of a “̂”-shaped stroke can be thereby obtained. Similarly, the “-”-shaped locus which is handwritten next with the pen 100 is also sampled, and time-series coordinates SD21, SD22, . . . , SD2n of a “-”-shaped stroke can be obtained.

The handwritten letter “B” is represented by two strokes handwritten with the pen 100, etc., that is, by two loci. The handwritten letter “C” is represented by one stroke handwritten with the pen 100, etc., that is, by one locus. A handwritten arrow is represented by two strokes handwritten with the pen 100, etc., that is, by two loci.

FIG. 4 shows time-series information 200 corresponding to the handwritten character string shown in FIG. 3. The time-series information 200 includes plural stroke data SD1, SD2, . . . , SD7. In the time-series information 200, the stroke data SD1, SD2, . . . , SD7 are arranged in the order of handwriting, that is, chronologically in the order in which plural strokes have been handwritten.

In the time-series information 200, the first two stroke data SD1 and SD2 represent two strokes of the handwritten letter “A”, respectively. Third stroke data SD3 and fourth stroke data SD4 represent two strokes constituting the handwritten letter “B”, respectively. Fifth stroke data SD5 represents one stroke constituting the handwritten letter “C”. Sixth stroke data SD6 and seventh stroke data SD7 represent two strokes constituting the handwritten arrow, respectively.

Each stroke data includes plural coordinates corresponding to plural points on a locus of one stroke, respectively. In each stroke data, the plural coordinates are arranged chronologically in the order in which the stroke has been written. For example, as for the handwritten letter “̂”, the stroke data SD1 includes coordinate data sequences (time-series coordinates) corresponding to the points on the locus of the “̂”-shaped stroke in the handwritten letter “̂”, that is, n coordinate data SD11, SD12, . . . , SD1n. The stroke data SD2 includes coordinate data sequences corresponding to the points on the locus of the “-”-shaped stroke in the handwritten letter “̂”, that is, n coordinate data SD21, SD22, . . . , SD2n. It should be noted that, within the stroke data, the number of the coordinate data may differ.

The coordinate data represents an X-coordinate and a Y-coordinate corresponding to a point in the corresponding locus. For example, the coordinate data SD11 represents x-coordinate (X11) and y-coordinate (Y11) of the start point of a “̂” shaped stroke. SDin represents X-coordinate (Xin) and Y-coordinate (Yin) of the end point of the “̂”-shaped stroke.

Furthermore, the coordinate data may include time stamp information T corresponding to a point in time that a point corresponding to the coordinates has been handwritten. The point in time at which the point has been handwritten may be either an absolute time (for example, year, month, day, hours, minutes, and seconds) or a relative time based on a certain point in time. For example, the absolute time (for example, year, month, day, hours, minutes, and seconds) when a stroke started to be written may be added as time stamp information, to each of the stroke data, and further the relative time representing the difference from the absolute time may be added as time stamp information T, to each of the coordinate data in the stroke data.

Furthermore, information (Z) indicating a pen pressure may be added to each of the coordinate data.

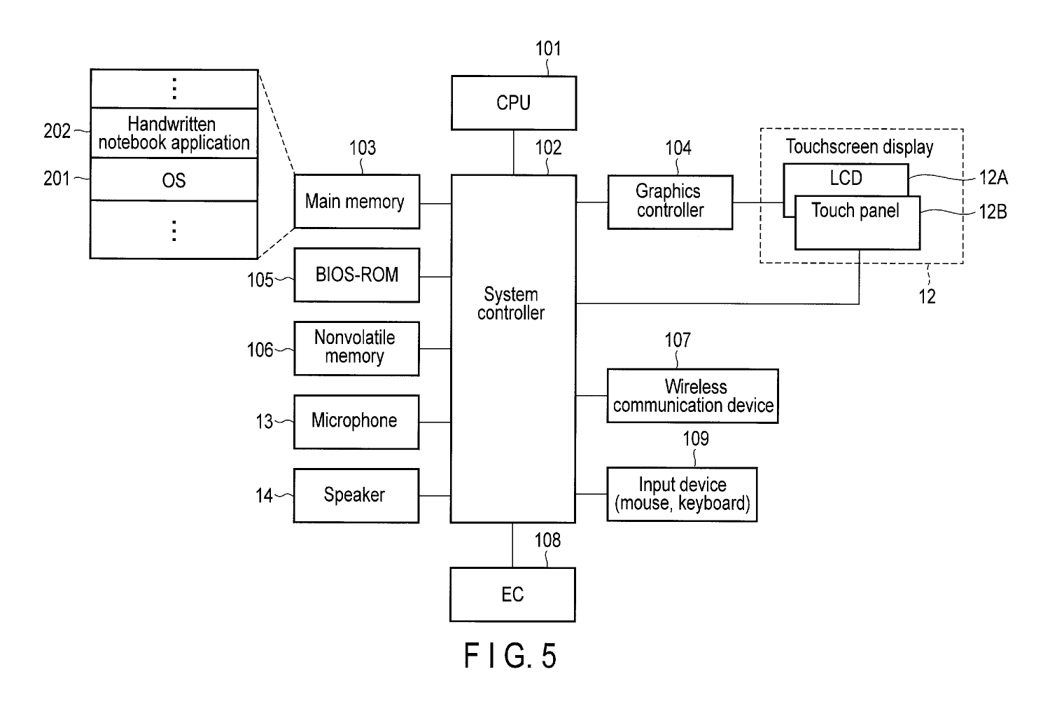

FIG. 5 shows a system configuration of the tablet computer 10.

As shown in FIG. 5, the tablet computer 10 comprises a CPU 101, a system controller 102, a main memory 103, a graphics controller 104, a BIOS-ROM 105, a nonvolatile memory 106, a wireless communication device 107, an embedded controller (EC) 108, etc.

The CPU 101 is a processor for controlling operations of various modules in the tablet computer 10. The processor comprises a processing circuit. The CPU 101 executes various computer programs loaded from the nonvolatile memory 106 serving as a persistent storage device to the main memory 103, which is typically volatile. These programs include an operating system (OS) 201 and various application programs. The application programs include a handwritten notebook application program 202. The handwritten notebook application program 202 is a digital notebook application that enables the user to take notes. The handwritten notebook application program 202 has the aforementioned function of creating and displaying a handwritten document, the function of editing a handwritten document, the autocomplete function, etc.

In addition, the CPU 101 also executes a basic input/output system (BIOS) stored in the BIOS-ROM 105. The BIOS is a program for hardware control.

The system controller 102 is a device configured to make connection between a local bus of the CPU 101 and the various components. The system controller 102 incorporates a memory controller which controls access to the main memory 103. In addition, the system controller 102 also has a function of communicating with the graphics controller 104 via a serial bus conforming to the PCI EXPRESS standard, for example. Furthermore, a sound controller which input speech data via a microphone 13 and outputs the speech data via a speaker 14 is built in the system controller 102.

The graphics controller 104 is a display controller which controls an LCD 12A used as a display monitor of the tablet computer 10. The display controller incorporates a display control circuit. The touchscreen display 12 including the LCD 12A (i.e., the screen of the touchscreen display 12/LCD 12A) is in a rectangular shape including two longer sides and two shorter sides.

A display signal produced by the graphics controller 104 is sent to the LCD 12A. The LCD 12A displays a screen image, based on the display signal. A touch panel 12B is arranged on the LCD 12A.

The wireless communication device 107 is a device configured to execute wireless communication such as wireless LAN and 3G mobile communication. The EC 108 is a single-chip microcomputer comprising an embedded controller for power management. The EC 108 has a function of powering on or off the tablet computer 10 according to a power button operation executed by the user.

In addition, the tablet computer 10 may comprise a peripheral interface to execute communication with input devices 109 (mouse, keyboard, etc.).

<Characteristics of Handwritten Notebook Application Program 202>

Several characteristics of the handwritten notebook application program 202 will be hereinafter explained.

<Basic Characteristics of Handwritten Notebook Application Program 202>

The handwritten notebook application program 202 stores a page under edit, periodically and automatically. When the handwritten notebook application program 202 is stopped/ended, the handwritten notebook application program 202 automatically stores the page under edit.

The handwritten notebook application program 202 supports plural languages. The handwritten notebook application program 202 uses a language set according to an OS setting.

The handwritten notebook application program 202 incorporates a character recognition engine and a speech recognition engine. The character recognition engine and the speech recognition engine support various languages such as Japanese, English, Korean, Russian and Chinese.

<Autocomplete Function>

The handwritten notebook application program 202 comprises an autocomplete function. The autocomplete function displays on the screen a list of handwriting candidates which are candidates determined based on “tentative” strokes input by handwriting. A “tentative” stroke means a stroke which can be autocompleted, i.e., a stroke input in the autocomplete mode. When any one of the handwriting candidates is selected by the user, the autocomplete function inputs the selected handwriting candidate instead of the tentative stroke.

1. User turns on the autocomplete mode (user interface can switch turning on and off the autocomplete mode).

2. User inputs a stroke (tentative stroke) on the screen. The stroke is displayed on the screen.

3. The handwritten notebook application program 202 determines several handwriting candidates and creates a handwriting candidate list (handwriting candidate menu). Each of the handwriting candidates is a stroke string including at least one stroke. The handwriting candidate may have a handwriting portion similar to the tentative stroke at its leading portion.

4. The handwritten notebook application program 202 displays the handwriting candidate list (handwriting candidate menu) on the screen. For example, when a tentative stroke corresponding to character “a” is input by the user, the handwriting candidate menu including the handwriting corresponding to a character string “apple”, the handwriting corresponding to a character string “application”, etc., may be displayed on the display.

5. When the user selects one of the handwriting candidates in the handwriting candidate menu, the handwritten notebook application program 202 inputs the handwriting candidate instead of the tentative stroke. In other words, the tentative stroke input by the user is completed by using the selected handwriting candidate, and the selected handwriting candidate is considered to be the entered handwriting. The size (height and character interval) of the handwriting candidate may be automatically adjusted to, for example, a size corresponding to the size of the stroke which has been input before the tentative stroke. Alternatively, the size of the tentative stroke may be used.

According to the autocomplete function, the handwriting candidate is extracted from the handwriting information previously input by the user. This means that the user can reuse the handwriting information previously input by the user. A set of handwriting collected from the handwriting information previously input by the user may be stored in an autocomplete dictionary database. The handwritten notebook application program 202 can automatically collect the set of handwriting from the user's handwritten notebook and store the set of handwriting in the autocomplete dictionary database. The handwritten notebook application program 202 can acquire at least one handwriting candidate defined by the tentative stroke from the autocomplete dictionary database. The user can also invalidate an arbitrary handwriting candidate in the autocomplete dictionary database. The invalidated handwriting candidate is not used in the autocomplete processing.

The handwritten notebook application program 202 displays the handwriting candidate list box as the handwriting candidate menu. For example, three handwriting candidates may be displayed in the handwriting candidate list box. The handwriting candidate list box includes three button areas. Three handwriting candidates are displayed in three button areas, respectively. Each button area is an operation area for selecting a corresponding handwriting candidate.

When the user taps an operation area corresponding to a certain handwriting candidate (for example, a button area corresponding to a certain handwriting candidate), the handwriting candidate corresponding to the operation area is entered (input) on the page. An enter button may be displayed in the handwriting candidate list box.

When the user taps the enter button, the handwritten notebook application program 202 enters (inputs) the tentative stroke on the page. A Show More button may be further displayed in the handwriting candidate list box.

When the user taps the Show More button, the handwritten notebook application program 202 increases the size of the handwriting candidate list box and displays the number displayed before tapping the Show More button, for example, more than three handwriting candidates.

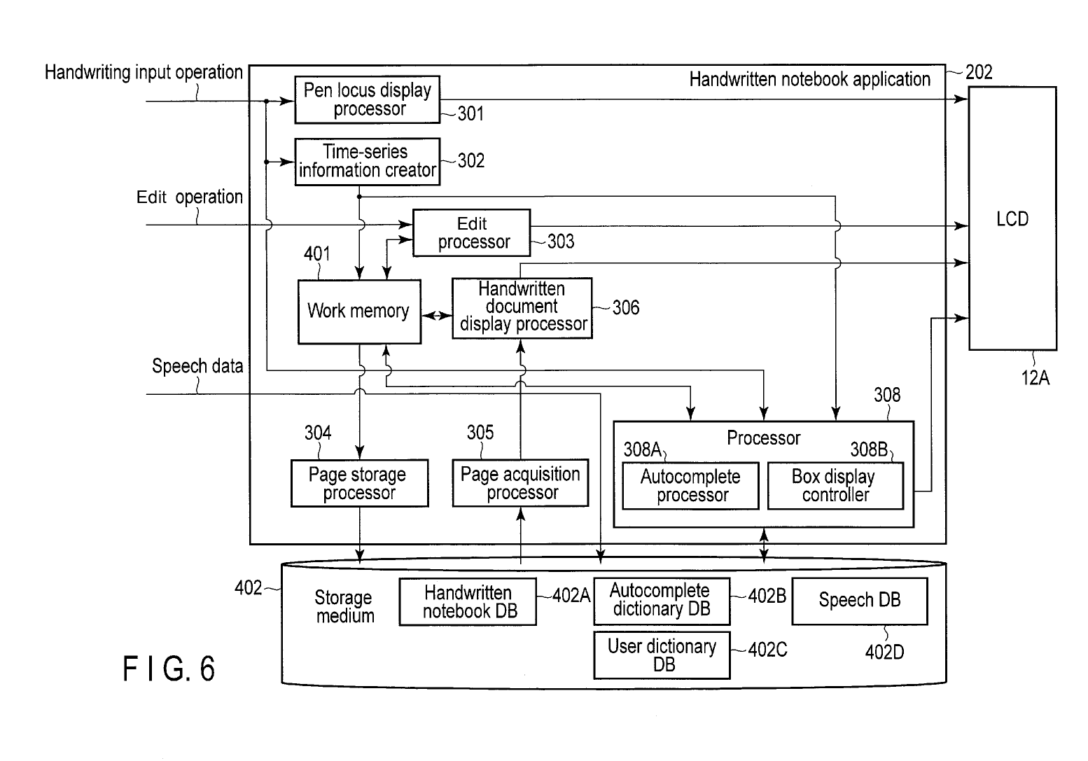

Next, a configuration of the handwritten notebook application program 202 will be explained with reference to FIG. 6.

The handwritten notebook application program 202 comprises instructions for configuring CPU 101 to function as a pen locus display processor 301, a time-series information creator 302, an edit processor 303, a page storage processor 304, a page acquisition processor 305, a handwritten document display processor 306, a processor 308, etc. In addition, the handwritten notebook application program 202 incorporates the character recognition engine and the speech recognition engine as explained above, though not shown in FIG. 6.

The handwritten notebook application program 202 executes creation, displaying, editing, etc., of the handwritten document (handwriting data) by using stroke data input by use of the touchscreen display 12. The touchscreen display 12 is configured to detect occurrence of an event such as “touch”, “move (slide)”, and “release”. “Touch” is an event indicating that an external object has made contact with the screen. “Move (slide)” is an event indicating that the contact position has been moved while an external object is in contact with the screen. “Release” is an event indicating that an external object has been separated from the screen.

The pen locus display processor 301 and the time-series information creator 302 receive the “touch” or “move (slide)” event produced by the touchscreen display 12 and thereby detects the handwriting input operation. The “touch” event includes the coordinates of the contact position. The “move (slide)” event also includes coordinates of a contact position of a movement destination. Therefore, the pen locus display processor 301 and the time-series information creator 302 can receive a coordinate string corresponding to the locus of the movement of the contact position from the touchscreen display 12.

The pen locus display processor 301 functions as a display controller configured to display the handwriting (at least one stroke) input by handwriting, on the screen of the touchscreen display 12. The pen locus display processor 301 receives the coordinate strings from the touchscreen display 12. Based on the coordinate strings, the pen locus display processor 301 displays plural strokes handwritten by the handwriting input operation using the pen 100, etc., on the screen of the LCD 12A in the touchscreen display 12. The pen locus display processor 301 can execute various display controls related to the display of the user interface, under control of the processor 308.

The time-series information creator 302 receives the above-explained coordinate strings output from the touchscreen display 12. The time-series information creator 302 creates plural stroke data (time-series information) corresponding to the plural strokes, based on the coordinate strings. The stroke data, i.e., the coordinates corresponding to respective points of each stroke and the time stamp information of each stroke, may be temporarily stored in a work memory 401.

The page storage processor 304 stores the handwritten document information including the plural stroke data corresponding to the plural strokes, in a handwritten notebook database 402A maintained in a storage medium 402. As described above, the storage medium 402 may be any one of the storage device of the tablet computer 10, the storage device in the personal computer 1, and the storage device of the server 2.

The page acquisition processor 305 reads arbitrary handwritten document information from the storage medium 402. The read handwritten document information is sent to the handwritten document display processor 306. The handwritten document display processor 306 analyzes handwritten document information and displays plural strokes indicated by the stroke data in the handwritten document information on the screen as a page (handwritten page), based on the analysis result.

The edit processor 303 executes processing for editing a currently displayed page. In other words, the edit processor 303 executes edit processing for erasing or moving at least one stroke of the plural displayed strokes in accordance with an editing operation executed by the user. Furthermore, the edit processor 303 updates the handwritten document to reflect a result of the edit processing on the displayed handwritten document.

The user can erase an arbitrary stroke in the plural displayed strokes by using an “eraser” tool, etc. In addition, the user can select an arbitrary portion in the displayed handwriting page by using a “select range” tool for surrounding an arbitrary portion on the screen by a rectangular or free frame.

The processor 308 can execute various types of processing including the above-explained autocomplete. The processor 308 comprises, for example, an autocomplete processor 308A, a box display controller 308B, etc.

The autocomplete processor 308A is a processor configured to execute the above-explained autocomplete function. In the autocomplete mode, the autocomplete processor 308A predicts handwriting, i.e., a stroke string (handwritten character string) which is to be handwritten by the user, based on the tentative stroke input by handwriting and the handwritten document information. The autocomplete processor 308A displays plural handwriting candidates determined based on the tentative stroke, on the screen of the LCD 12A. In the display area of the plural handwriting candidates (above-explained handwriting candidate list box), the handwriting candidates are arranged in higher priority.

For example, if a tentative stroke “a” is input by handwriting, handwriting candidates such as a handwritten word “add” or “access” may be presented to the user. If the handwritten word “access” is selected by the user, the tentative stroke “a” is completed by the handwritten word “access”. Then, the handwritten word “access” is entered on the page instead of the tentative stroke “a”. The user can therefore easily input the handwritten word “access”.

If no handwriting candidates are selected but a next tentative stroke, for example, “b” is input, then the autocomplete processor 308A displays a list of handwriting candidates determined by two tentative strokes “ab” in the handwriting candidate list box and presents the list to the user.

Any languages may be used as languages of the handwritten character strings stored in the handwritten document information. Examples of available languages include English, Japanese, and other various languages. As for an English character string, the handwriting (handwritten character string) may be a stroke string corresponding to a character string of block letters or a stroke string corresponding to a cursive character string. A handwritten cursive word is often composed of one stroke. Therefore, each handwriting element (stroke string) acquired from the handwritten document information in the autocomplete processing does not need to include plural strokes, but may be one stroke.

To easily specify the handwriting candidates determined based on the tentative stroke, the autocomplete processor 308A may automatically collect the handwriting such as the handwritten character string from a stroke set (handwritten document information) stored in the handwritten notebook database 402A and store the automatically collected handwritten character string in the autocomplete dictionary database 402B.

In the autocomplete dictionary database 402B, for example, the handwriting (stroke strings) and words corresponding to the handwriting (character recognition result) may be stored in units of character strings having some meaning (for example, units of words). Furthermore, besides words and the handwriting (stroke strings), different readings corresponding to the words may be stored in the autocomplete dictionary database 402B. If words are English, aliases of the words may be stored instead of the reading of the words, in the autocomplete dictionary database 402B.

The autocomplete processor 308A may first recognize the tentative stroke input by the user. The autocomplete processor 308A finds a word which matches prefix of the character recognition result (character string) of the tentative stroke, by referring to the autocomplete dictionary database 402B. The autocomplete processor 308A acquires the handwriting (character string) corresponding to the found word from the autocomplete dictionary database 402B as a handwriting candidate determined based on the tentative stroke.

Alternatively, handwriting (stroke strings) and a feature value corresponding to the handwriting may be stored in units of, for example, words, in the autocomplete dictionary database 402B. As the feature value of certain handwriting, an arbitrary feature which can represent a handwriting feature of the handwriting can be used. For example, feature value representing a stroke shape, a direction of drawing the stroke, a stroke inclination, etc., may be used. In this case, the autocomplete processor 308A may acquire a handwriting candidate having a feature value similar to the feature value of the tentative stroke from the autocomplete dictionary database 402B.

Furthermore, additional information corresponding to each handwriting element may be registered in units of, for example, words, in the autocomplete dictionary database 402B. The additional information may include information indicating an appearance frequency (co-occurrence probability) of each handwriting element in the handwritten document information. Furthermore, the additional information may include information indicating the frequency of use of each handwriting element. The frequency of use of each handwriting element may be, for example, a count at which each handwriting element is selected from the handwriting candidate list box.

The autocomplete processor 308A acquires several handwriting candidates corresponding to the tentative stroke from the autocomplete dictionary database 402B, by using at least either of the feature amount of the tentative stroke and the character recognition result of the tentative stroke. Each of the handwriting candidates may be the handwriting having a feature value similar to the feature value of the tentative stroke or the handwriting which matches prefix of the character recognition result of the tentative stroke. Alternatively, each of the handwriting candidates may be the handwriting which has a feature value similar to the feature value of the tentative stroke and which corresponds to the character string matching the prefix of the character recognition result of the tentative stroke.

The autocomplete processor 308A determines priorities (priority orders) of the respective handwriting candidates for ranking of the handwriting candidates. In processing for ranking of the handwriting candidates, a score may be given to each handwriting candidate. The score of each handwriting candidate may be determined in accordance with similarity of the feature value of the tentative stroke to the feature value of the handwriting candidate. The handwriting candidate having a higher similarity is given a high score. The handwriting candidate having the highest score is given the highest priority.

Alternatively, the score of each handwriting candidate may be determined in accordance with an appearance frequency of the handwriting candidate or a use frequency of the handwriting candidate. The handwriting candidate having a higher appearance frequency is estimated to be the handwriting which could be input by the user at a high possibility. For this reason, the handwriting candidate having a higher appearance frequency is given a higher score. The handwriting candidate having a higher use frequency is also estimated to be the handwriting which could be input by the user at a high possibility. For this reason, the handwriting candidate having a higher use frequency (number of selections) may be given a higher score.

Alternatively, the score of each handwriting candidate may be determined based on all of (1) the similarity of the feature value of the tentative stroke to the feature value of the handwriting candidate, (2) the appearance frequency of the handwriting candidate, and (3) the number of selections of the handwriting candidate.

Furthermore, the autocomplete processor 308A can use speech data input via the microphone 13 to acquire several handwriting candidates corresponding to the tentative stroke from the autocomplete dictionary database 402B. The handwritten notebook application program 202 starts inputting the speech data when for example, the autocomplete mode is turned on. The speech data is stored in a speech database 402D in the storage medium 402 together with the speech recognition result of the speech recognition engine. Time stamp information corresponding to the time when the speech data is input is attached to the speech data in the speech database 402D. For example, if a word matching the speech recognition result of the speech data is present in the autocomplete dictionary database 402B and handwriting corresponding to the word has a feature value similar to the feature amount of the tentative stroke, the autocomplete processor 308A acquires the handwriting as a handwriting candidate having a high score. For this reason, if it is determined that, for example, human voice is input and the speech recognition of the speech recognition engine is executed, the autocomplete processor 308A determines whether a word which matches the speech recognition result is present in the autocomplete dictionary database 402B or not and, if the word is present, adds information indicating the word which matches the speech recognition result of the speech data to the speech data to acquire the handwriting corresponding to the word as a handwriting candidate having a high score. In other words, the autocomplete processor 308A controls the priority of the handwriting stored in the autocomplete dictionary database 402B, with the speech data. The handwriting corresponding to a word which appears in user's conversation can be estimated as handwriting which could be input by the user at a high possibility. It should be noted that the information indicating the word which matches the speech recognition result of the speech data should preferably include the time stamp information corresponding to the time when the speech data is input.

The autocomplete processor 308A can also use a user dictionary database 402C. The user dictionary database 402C stores a number of prepared handwriting candidates. These handwriting candidates are handwriting elements corresponding to a number of words, respectively. The user can register new handwriting in the user dictionary database 402C. Furthermore, the user can delete arbitrary handwriting in the user dictionary database 402C.

The box display controller 308B controls a display position of the handwriting candidate list box, a layout of the handwriting candidate list box, and an arrangement order of the handwriting candidates in the handwriting candidate list box. Since the handwriting candidates having higher priorities (priority orders) are the candidates who could be selected by the user at higher possibilities, the box display controller 308B displays the handwriting candidates in the handwriting candidate list box according to the priorities of the handwriting candidates. In other words, the box display controller 308B controls display of the handwriting candidate list box by considering the priorities of the handwriting candidates and the display positions of the handwriting candidates, such that the user can easily select the candidates.

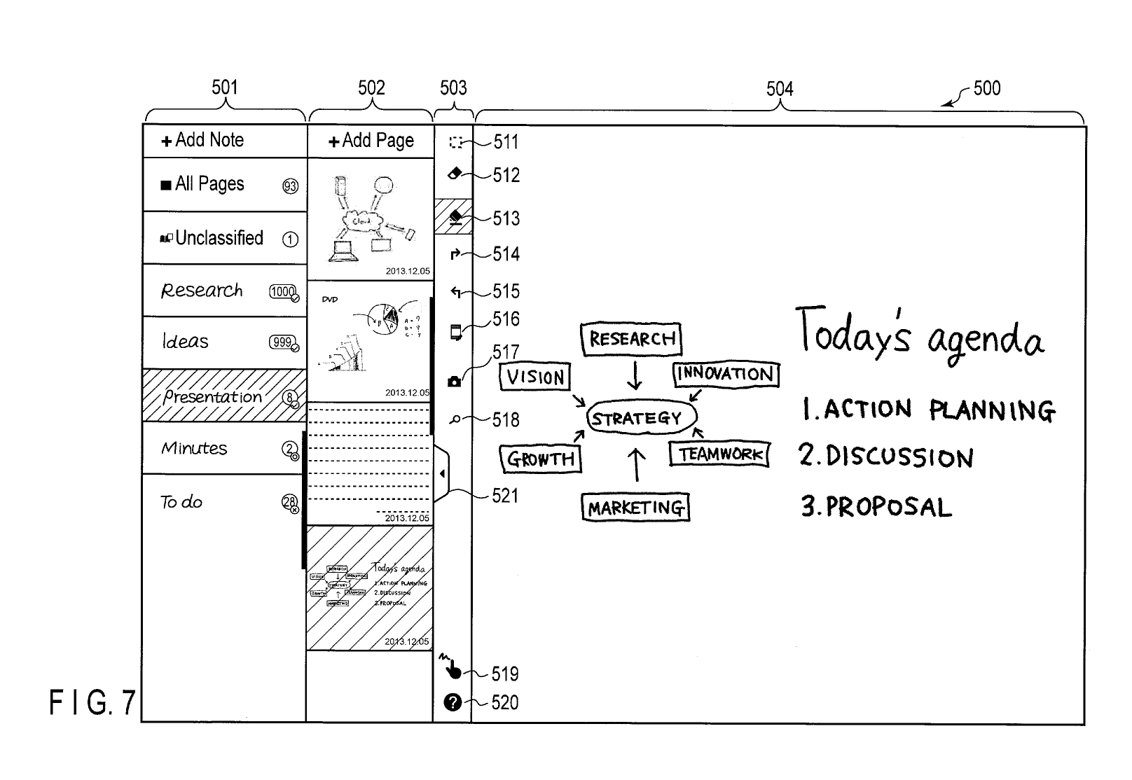

FIG. 7 shows a user interface (edit screen 500) of the handwritten notebook application program 202. The handwritten notebook application program 202 can display the edit screen 500 shown in FIG. 7. The edit screen 500 includes four areas, i.e., a notebook list 501, a page list 502, an edit tool bar 503, and an edit view area 504.

The notebook list 501 indicates a list of notebooks managed by the handwritten notebook application program 202. Two icons “Add Note” and “All Pages” near an upper end of the notebook list 501 are command icons. When “Add Note” icon is tapped by the user, the processor 308 executes processing for adding a new notebook. When “All Pages” icon is tapped by the user, the processor 308 executes processing for displaying a list of thumbnails corresponding to all pages in all the notebooks.

“Unclassified pages” icon is a notebook icon indicating a notebook including a page group which does not belong to any user notebooks. “Research” icon is a notebook icon indicating a user notebook (titled “Research”). “Ideas” icon is a notebook icon indicating a user notebook (titled “ideas”). “Presentation” icon is a notebook icon indicating a user notebook (titled “presentation”). “Minutes” icon is a notebook icon indicating a user notebook (titled “Minutes”). “ToDo” icon is a notebook icon indicating a user notebook (titled “ToDo”).

The notebook icons can be rearranged by drag and drop operations.

The page list 502 indicates a list of thumbnails corresponding to pages included in a notebook corresponding to a currently selected notebook icon.

“Add Page” icon at an uppermost position in the page list 502 is a command icon. When “Add Page” icon is tapped by the user, the processor 308 executes processing for adding a new page to the notebook under edit.

Plural page icons representing respective thumbnails corresponding to the plural pages are arranged on a lower side of “Add Page” icon. Strokes included in a page corresponding to the selected page icon are displayed in the edit view area 504. The user can display an arbitrary page in the edit view area 504 by selecting one of the page icons in the page list 502.

These page icons can be rearranged by drag and drop operations. The user can change (customize) the page order by the drag and drop operations of the page icons.

The edit tool bar 503 includes several buttons for editing the pages. “Selection pen” button 511 is used as a “Select range” tool. The user can select at least one object in the edit view area 504 with the “Selection pen”. When the “Selection pen” button 511 is tapped by the user, the processor 308 displays a menu for changing a selection type (rectangular shape/free frame/select all).

“Eraser pen” button 512 is used as an “eraser” tool. The user can erase at least one stroke in the edit view area 504 with the “Eraser pen”. When the “Eraser pen” button 512 is tapped by the user, the processor 308 displays a menu for changing an eraser size (large/small/entire page).

“Stroke input pen” button 513 is used to draw a stroke. The user can draw handwriting (stroke) in the edit view area 504 by the “stroke input pen”. When the “Stroke input pen” button 513 is tapped by the user, the processor 308 displays a menu for showing several preset pens. Each of the preset pens defines a combination of, for example, pen type (fountain pen/pencil/ball-point pen/pencil/highlighter/felt pen), width, color, and transparency. The user can select a pen from the menu.

“Undo” button 515 is used to cancel the edit operation. “Redo” button 514 is used to redo the edit operation.

“Autocomplete (recommended input)” button 516 is a button to turn on off the autocomplete mode.

“Camera” button 517 is used to take a photograph and import the photograph in the edit view area 504. The user can take a photograph with the “Camera” button 517. The processor 308 starts a capture application program. The capture application program captures an image (photograph) with a camera (Web cam) provided on the tablet computer 10. The processor 308 imports the captured image.

“Search” button 518 is a button to open an input window in which search terms can be entered. “Touch input mode” button 519 is a button to turn on off a touch input mode which enables drawing with a finger or a mouse.

“Help” button 520 is a button to display help. A tab button 521 is a button to change normal mode/full-screen mode. The user interface (edit screen 500) shown in FIG. 7 corresponds to the normal mode.

The edit view area 504 is a handwriting input area where handwriting input can be executed. The user can handwrite a stroke at a desired portion in the edit view area 504. When the user taps the “Autocomplete (recommended input)” button 516, the autocomplete mode is turned on. When the autocomplete mode is turned on, a list of handwriting candidates corresponding to the strokes (tentative strokes) input by handwriting is displayed in the edit view area 504 as input candidates.

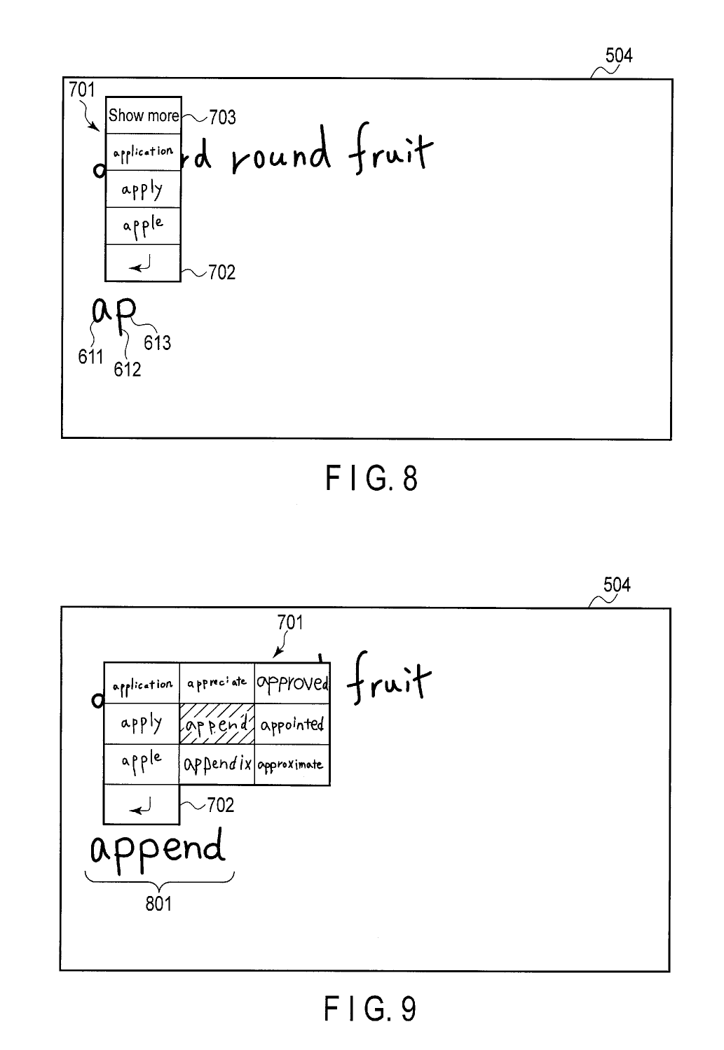

FIG. 8 shows the handwriting candidate list box displayed in the edit view area 504.

If a tentative stroke 611 corresponding to letter “a” and tentative strokes 612 and 613 corresponding to letter “p” are input by the user, a tentative stroke string corresponding to handwritten character string “ap” is displayed in the edit view area 504. Furthermore, a handwriting candidate list box 701 is displayed at an upper portion of the tentative stroke string. Three handwriting candidates who correspond to three words “apple”, “apply” and “application” including “ap”, respectively, are displayed. These handwriting candidates can be obtained by searching for handwriting corresponding to the tentative strokes 611 to 613 from the autocomplete dictionary database 402B. Each of the handwriting candidates is a stroke string including at least one stroke. Each handwriting candidate may be the handwriting including handwriting similar to the tentative stroke string at its leading portion. The handwriting candidate list box 701 includes three button areas. Three handwriting candidates are displayed in three button areas, respectively.

When the user taps an arbitrary button area in the handwriting candidate list box 701, the handwriting candidate corresponding to the tapped button area is entered (input) to the page under editing. In other words, the tentative stroke string (at least one stroke) input by the user is completed by using the selected handwriting candidate. The handwriting candidate is the entered handwriting. The user can thereby easily handwrite the desired handwriting without handwriting all handwriting elements.

Priorities of the handwriting candidates displayed in the button areas are higher in the order of being closer from the input position of the tentative stroke string. In the example shown in FIG. 8, the priority of “apple” is highest, and the priorities of “apply” and “application” are lower in order. Since the handwriting candidate who could be selected by the user is closer to the input position of the tentative stroke string, the user can easily select a target handwriting candidate by merely executing an operation of slightly moving a fingertip similarly to moving a pen tip.

Enter button 702 may be displayed in the handwriting candidate list box 701. When the Enter button 702 is tapped, the input (entered) stroke is the tentative stroke.

Show More button 703 may be further displayed in the handwriting candidate list box 701. When the Show More button 703 is tapped, the handwritten notebook application program 202 increases the size of the handwriting candidate list box 701 and displays more than three candidate handwriting elements as shown in, for example, FIG. 9. Nine button areas of three rows×three columns including additional two rows are arranged, and six candidate handwriting elements are further displayed. The priority of the handwriting candidate additionally displayed by tapping the Show More button 703 is lower than the priorities of the handwriting candidates which have been displayed before tapping the Show More button 703.

If the desired handwriting is not included in the handwriting candidate list box 701, the user handwrites a further new tentative stroke at a position subsequent to the tentative stroke strings 611 to 613. If the tentative stroke is further input by handwriting, the handwriting candidates in the handwriting candidate list box 701 are updated to handwriting candidates obtained from the tentative stroke strings 611 to 613 and the new tentative stroke.

It is assumed here that the user considers handwriting a character string “append” (displayed as the handwriting candidate in the handwriting candidate list box 701 shown in FIG. 9). In this case, the user first handwrites, for example, a character string “ap” and confirms whether a handwriting candidate corresponding to the character string “append” is included in the displayed handwriting candidate list box 701 or not. Since a handwriting candidate corresponding to the character string “append” is not included in the initial handwriting candidate list box 701 as shown in FIG. 8, the user taps the Show More button 703 in the initial handwriting candidate list box 701 and further confirms whether a handwriting candidate corresponding to the character string “append” is included in the displayed handwriting candidate list box 701 or not. Since a handwriting candidate corresponding to the character string “append” is included in the displayed handwriting candidate list box 701 of the enlarged size, the user can complete handwriting the character string “append” (801) by tapping a button area where the character string “append” is displayed.

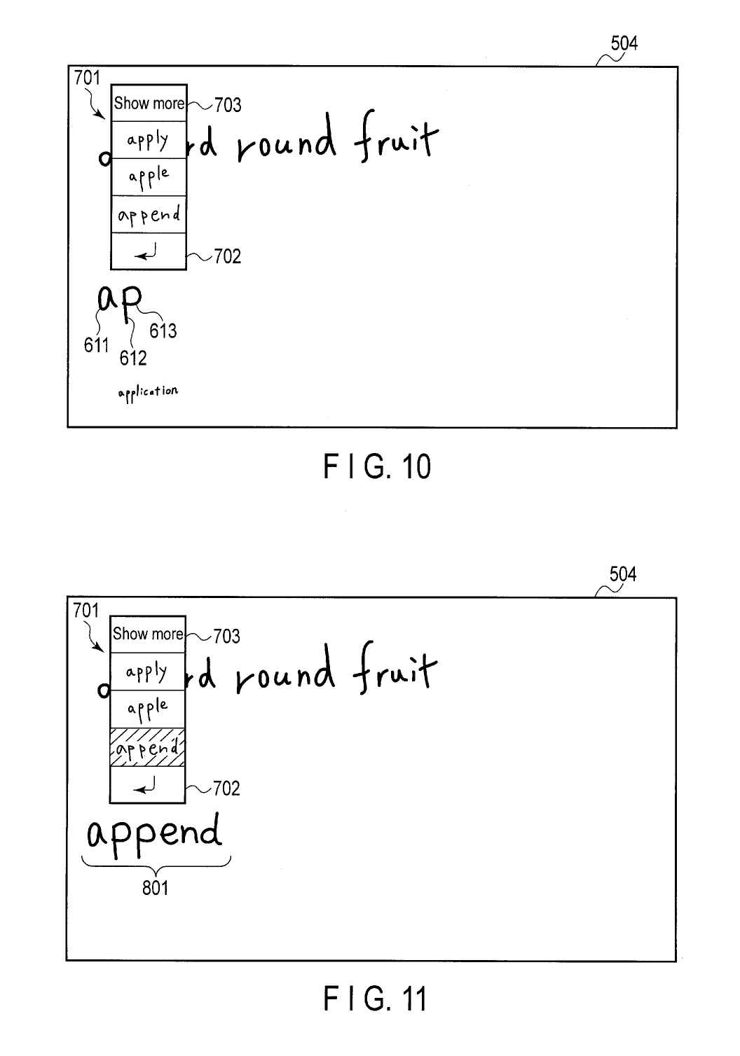

Incidentally, for example, if the user executes handwriting on the touchscreen display 12 of the tablet computer 10 to take notes in a conference and speech including the word “append” is made in the conference, the handwriting corresponding to the character string “append” should preferably be given a high priority, as the handwriting candidate set under the condition that the character string “ap” is input by handwriting. More specifically, since the handwriting corresponding to the character string “append” is the handwriting which could be selected by the user at a high probability, the handwriting should desirably be included in the initial handwriting candidate list box 701 as shown in FIG. 10. Thus, tapping the Show More button 703 in the handwriting candidate list box 701 would be unnecessary, and continuing the handwriting of the tentative stroke without considering that the handwriting corresponding to the character string “append” has been acquired as the handwriting candidate can be prevented. In this case, the user can complete handwriting the character string “append” (801) by tapping the button area where the character string “append” is displayed, which is included in the initial handwriting candidate list box 701. In other words, convenience can be further enhanced.

Considering this point, the autocomplete processor 308A controls the priority of the handwriting stored in the autocomplete dictionary database 402B, with the speech data, by recognizing that the handwriting corresponding to the word which appears in user's conversation can be estimated as handwriting which could be input by the user at a high possibility, as explained above.

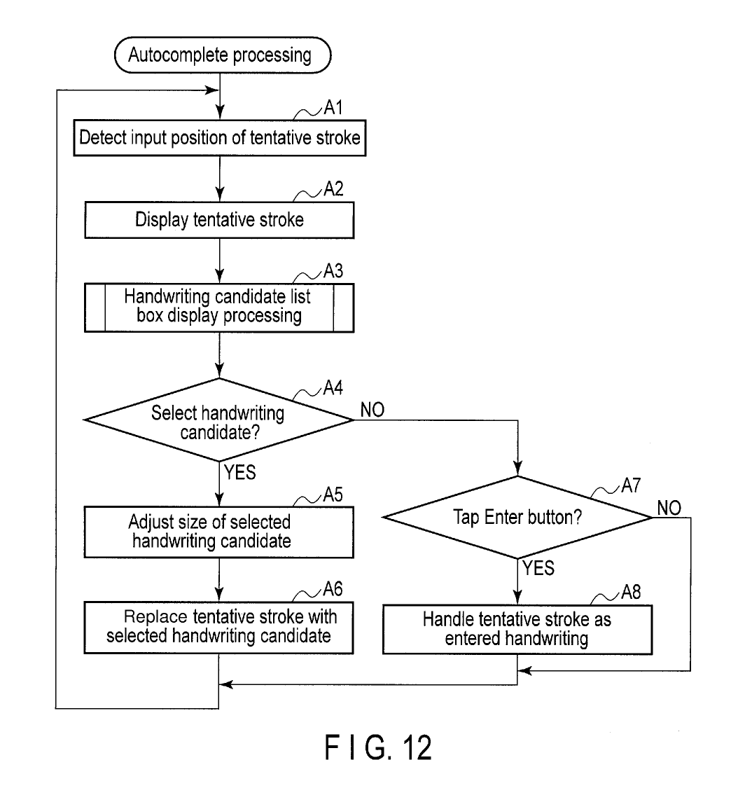

FIG. 12 is a flowchart showing procedures of the autocomplete processing executed by the CPU 101 under control of the handwritten notebook application program 202.

When the tentative stroke is input by handwriting, the CPU 101 detects the input position of the tentative stroke in the edit view area 504 (block A1). The CPU 101 executes processing for displaying the tentative stroke in the edit view area 504 (block A2). Then, the CPU 101 displays the handwriting candidate list box 701, which is the handwriting candidate display area, at a position defined by the input position of the tentative stroke (block A3). In the handwriting candidate list box 701, the list of the handwriting candidates defined by the tentative stroke is displayed.

The CPU 101 determines whether the handwriting candidate is selected or not (block A4). If the handwriting candidate is selected by the user (YES in block A4), the CPU 101 adjusts the size of the selected handwriting candidate (block A5). The CPU 101 replaces the tentative stroke with the selected handwriting candidate and handles the selected handwriting candidate as the entered handwriting (block A6). In other words, the selected handwriting candidate is input instead of the tentative stroke.

If no handwriting candidate is selected (NO in block A4), the CPU 101 determines whether the Enter button is tapped or not (block A7). If the Enter button is tapped (YES in block A7), the CPU 101 handles the tentative stroke as the entered handwriting (block A8).

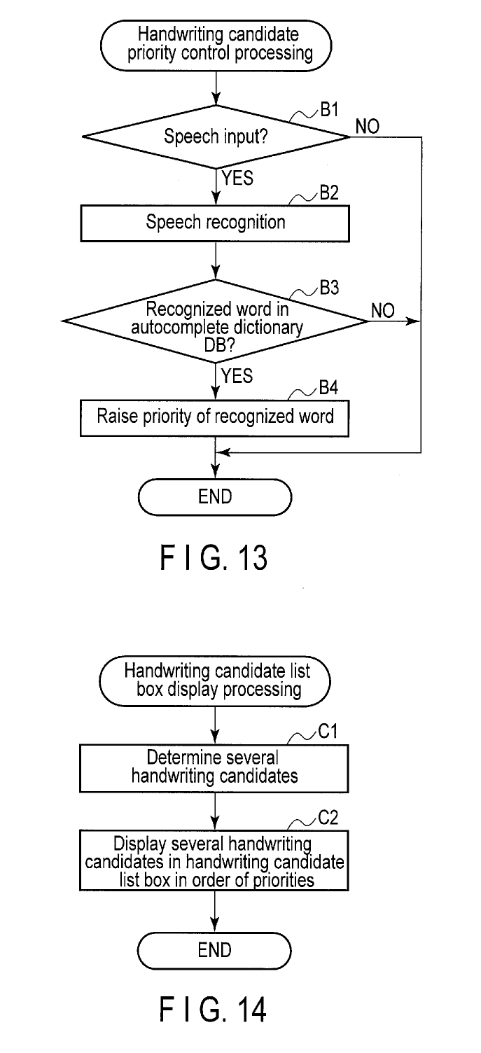

FIG. 13 is a flowchart showing procedures of handwriting candidate priority control processing executed by the CPU 101 under control of the handwritten notebook application program 202.

For example, if the speech data input via the microphone 13 is speech data at a sound pressure equal to or higher than a predetermined sound pressure, in a predetermined frequency band, the CPU 101 determines that speech is input (block B1) and executes speech recognition (block B2). The CPU 101 determines whether a recognized word is present in the autocomplete dictionary database 402 or not (block B3) and, if the recognized word is present (YES in block B3), the CPU 101 executes processing for raising the priority of the recognized word in the autocomplete dictionary database 402 to enable the handwriting corresponding to the word to be easily acquired as the handwriting candidate (block B4).

FIG. 14 is a flowchart showing procedures of handwriting candidate list box display processing executed by the CPU 101 under control of the handwritten notebook application program 202.

The CPU 101 determines several handwriting candidates from at least one input tentative stroke (block C1). Since the priority of the handwriting corresponding to the word recognized by the speech recognition is raised, the handwriting can easily be determined as the handwriting candidates. Then, the CPU 101 displays the handwriting candidates in order of priorities on the screen (block C2).

Incidentally, when the speech data input via the microphone 13 is used to acquire several handwriting candidates corresponding to the tentative stroke from the autocomplete dictionary database 402B, as explained above, various rules to select, for example, speech to be applied, etc., can be employed.

For example, as for the tentative stroke input by handwriting during editing of a certain page, speech in the speech data input after editing of the page has started, may be applied. Alternately, speech in the speech data in which a time interval from the time when the tentative stroke is input by handwriting (i.e., a time difference from the time when the speech data is input) falls within a predetermined range may be applied. Furthermore, the handwriting corresponding to the word recognized with speech closer to the time when the tentative stroke is input by handwriting may have higher priority.

In addition, the tablet computer 10 of the present embodiment may comprise a handwriting collaboration engine. The handwriting collaboration engine executes handwriting sharing service which enables handwriting information to be shared among plural electronic devices. The handwriting sharing service enables the user of each electronic device to view the shared handwriting information and to edit the handwriting information by collaborating with the users of the other electronic devices. The handwriting sharing service may be utilized in a conference. Speech in the speech data input after the use of the handwriting sharing service is used, may be applied. Summary of the handwriting sharing service will be hereinafter briefly explained.

The handwriting sharing service distributes the stroke data handwritten with an electronic device which participates in (logs in) the service, to each of the other electronic devices that participate in (log in) the service, in real time. Contents of the handwritten document displayed on the display screens of the electronic devices can be thereby synchronized with each other. In addition, the handwriting sharing service can display stroke data handwritten by different users, in different modes (for example, different colors, different widths, different pen types, etc.).

The handwriting sharing service is utilized by a group of persons. The group of persons utilizing the handwriting sharing service may include an owner (host) and at least one participant. The owner is also a participant who participates in the group.

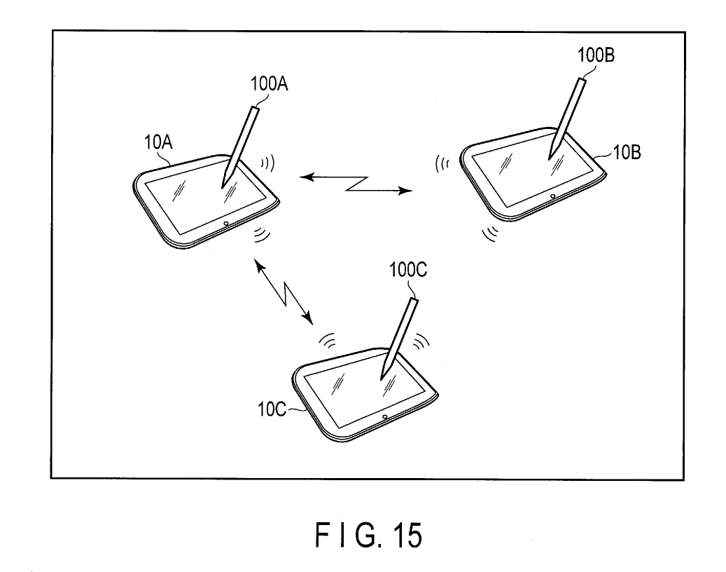

FIG. 15 shows an example of communication between the electronic devices utilizing handwriting sharing service.

An electronic device 10A is a tablet computer used by a user A. An electronic device 10B is a tablet computer used by a user B. An electronic device 10C is a tablet computer used by a user C. Each of the electronic devices 10A, 10B and 10C comprises a handwriting collaboration engine that is equivalent to that of the tablet computer 10 of the present embodiment.

The electronic devices 10A, 10B and 10C are connected to and communicate with each other via a wired network or a wireless network. Mutual connection of the electronic devices 10A, 10B and 10C via a wireless network is hereinafter assumed. An arbitrary wireless connection standard capable of making wireless connection between plural devices can be applied as a method of making wireless connection of the electronic devices 10A, 10B, and 10C. For example, Wi-Fi Direct®, Bluetooth®, etc., may be employed.

Any one of the electronic devices 10A, 10B and 10C can function as a server configured to manage the handwriting sharing service. The owner's electronic device may play a role of the server. The owner corresponds to the host of the handwriting sharing service.

The server may determine whether each electronic device requesting participation in the handwriting sharing service is permitted to participate in the handwriting sharing service (group), i.e., to permit the electronic device to log into the handwriting sharing service, or not. The only device (terminal) receiving permission of participation (login) from the server may be permitted to log into the handwriting sharing service, i.e., to participate in the group.

As for the method in which each device (terminal) logs into the handwriting sharing service, a method of logging into the handwriting sharing service with an ID (account) of the device may be employed. Alternatively, a method of logging into the handwriting sharing service with an ID (account) of the user using the device may be employed. In other words, login to and logout from the handwriting sharing service may be either login and logout using the ID (account) of the electronic device or login and logout using the ID (account) of the user.

It is assumed here that the electronic devices 10A, 10B and 10C log into the handwriting sharing service, i.e., the electronic devices 10A, 10B and 10C participate in the common handwriting sharing service. A handwriting sharing screen (canvas) for viewing the shared handwriting information is displayed on each of the electronic devices 10A, 10B and 10C. The handwriting sharing screens (canvases) are used as display areas common to the electronic devices 10A, 10B and 10C. The handwriting sharing screens (canvases) enable visual communication among the electronic devices 10A, 10B and 10C. The visual communication enables the handwriting information and other various electronic documents to be exchanged between the devices.

The stroke data which each of the users A, B, and C handwrites at the own electronic device is not only displayed on the handwriting sharing screen (canvas) of the own electronic device, but also reflected on the handwriting sharing screen (canvas) of each of the other electronic devices in real time. Consequently, the stroke data (handwritten characters, handwritten graphics, etc.) handwritten by each of the users A, B, and C can be exchanged and shared among the users A, B, and C.

Furthermore, the electronic devices 10A, 10B and 10C can also display the same contents such as a reference material for conference on the canvases. In this case, the stroke data handwritten at each electronic device is displayed on the contents. The users A, B, and C can exchange and share the handwritten characters, handwritten graphics, etc., handwritten on the contents among the users A, B, and C, while viewing the same contents.

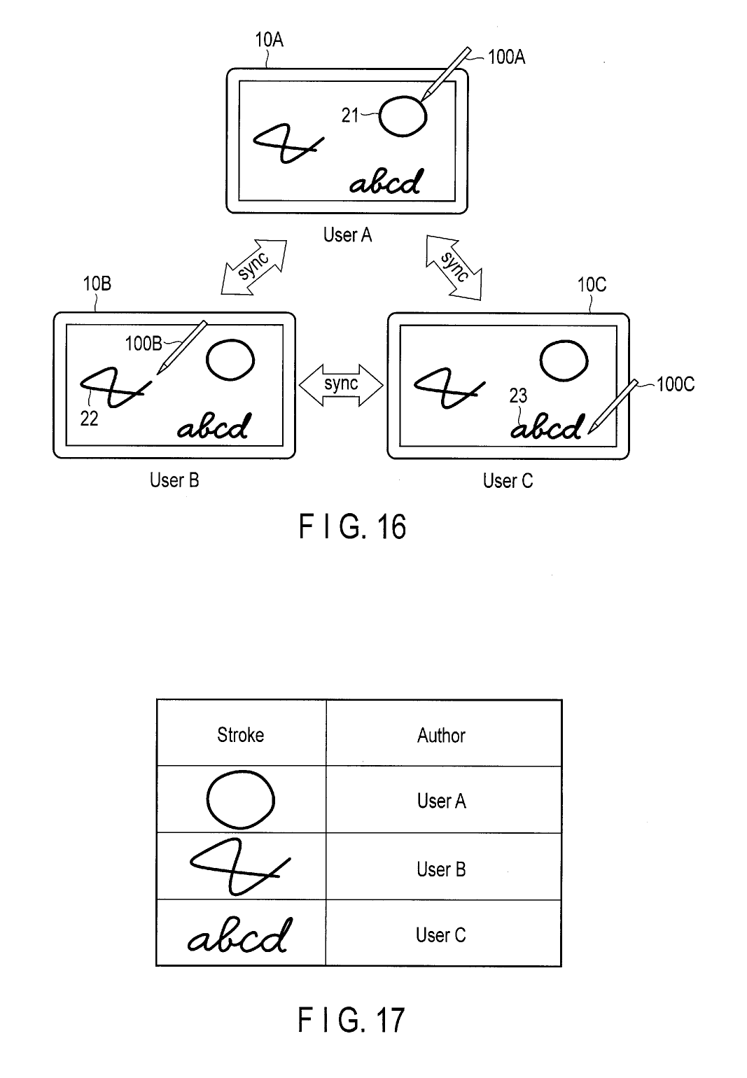

FIG. 16 shows processing of sharing the same canvas among the electronic devices (terminals) 10A, 10B and 10C.

The handwriting sharing service allows the electronic devices (terminals) 10A, 10B and 10C to make wireless communication with each other. Then, the handwriting sharing service enables simultaneous handwriting on the same canvas by plural persons by synchronizing screen displays and handwriting operations of the respective terminals with each other.

On the canvases of the respective electronic devices (terminals) 10A, 10B and 10C, same strokes 21, 22 and 23 are displayed. The stroke 21 is a stroke handwritten on the electronic device 10A by the user A as shown in FIG. 17. The stroke 22 is a stroke handwritten on the electronic device 10B by the user B. The stroke 23 is a stroke handwritten on the electronic device 10C by the user C.

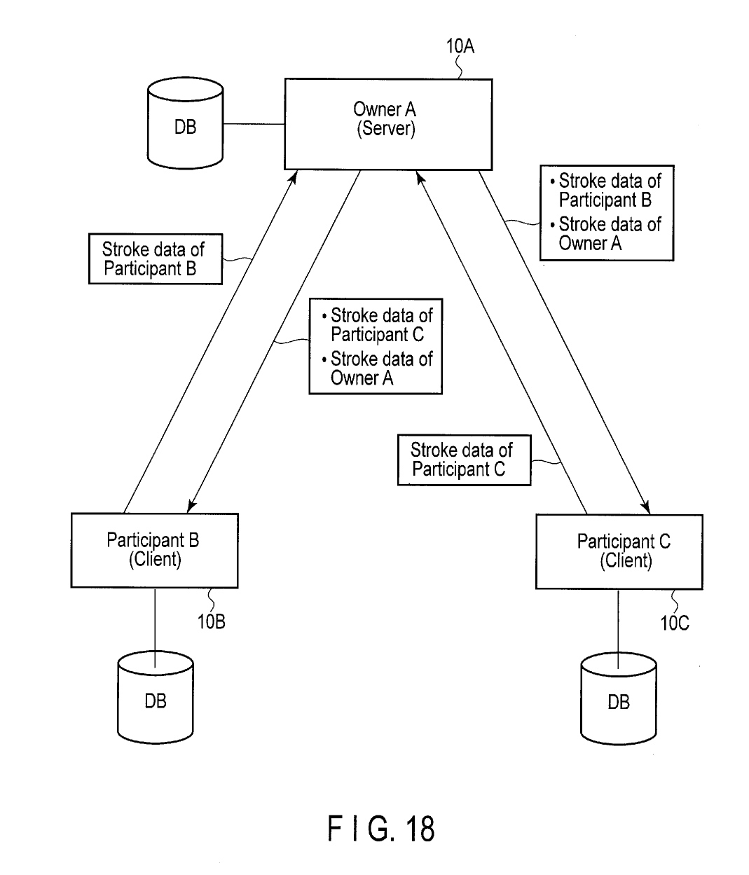

FIG. 18 shows flows of data between the electronic devices.

The electronic device 10A is assumed to operate as a server of a system which executes the handwriting sharing service, in FIG. 18. In other words, the user A of the electronic device 10A is the owner (Owner A), the user B of the electronic device 10B is the participant (Participant B), and the user C of the electronic device 10C is the participant (Participant C). Each of the electronic devices 10B and 10C functions as a client.

The electronic device 10A receives stroke data corresponding to a stroke handwritten at the electronic device 10B (i.e., stroke data of Participant B) from the electronic device 10B. In addition, the electronic device 10A receives stroke data corresponding to a stroke handwritten at the electronic device 10C (i.e., stroke data of Participant C) from the electronic device 10C.

Furthermore, the electronic device 10A sends stroke data corresponding to a stroke handwritten at the electronic device 10A (i.e., stroke data of Owner A) and the stroke data corresponding to the stroke handwritten at the electronic device 10C (i.e., stroke data of Participant C), to the electronic device 10B. Moreover, the electronic device 10A sends the stroke data corresponding to the stroke handwritten at the electronic device 10A (i.e., stroke data of Owner A) and the stroke data corresponding to the stroke handwritten at the electronic device 10B (i.e., stroke data of Participant B), to the electronic device 10C.

Thus, not only the stroke data of Owner A, but also the stroke data of Participant B and the stroke data of Participant C are displayed on the display of the electronic device 10A.

Similarly, not only the stroke data of Participant B, but also the stroke data of Owner A and the stroke data of Participant C are displayed on the display of the electronic device 10B.

Similarly, not only the stroke data of Participant C, but also the stroke data of Owner A and the stroke data of Participant B are displayed on the display of the electronic device 10C.

Each of the electronic devices 10A, 10B and 10C stores the stroke data corresponding to the stroke handwritten locally in a local database. Furthermore, each of the electronic devices 10A, 10B and 10C also stores the stroke data received from the other electronic devices in the local database.

If the speech data input via the microphone 13 is used to acquire several handwriting candidates corresponding to the tentative strokes from the autocomplete dictionary database 402B, based on start of use of such handwriting sharing service, the handwriting candidates acquired by the autocomplete function assuming a scene in which notes are taken in a conference using the handwriting sharing service can be corrected.

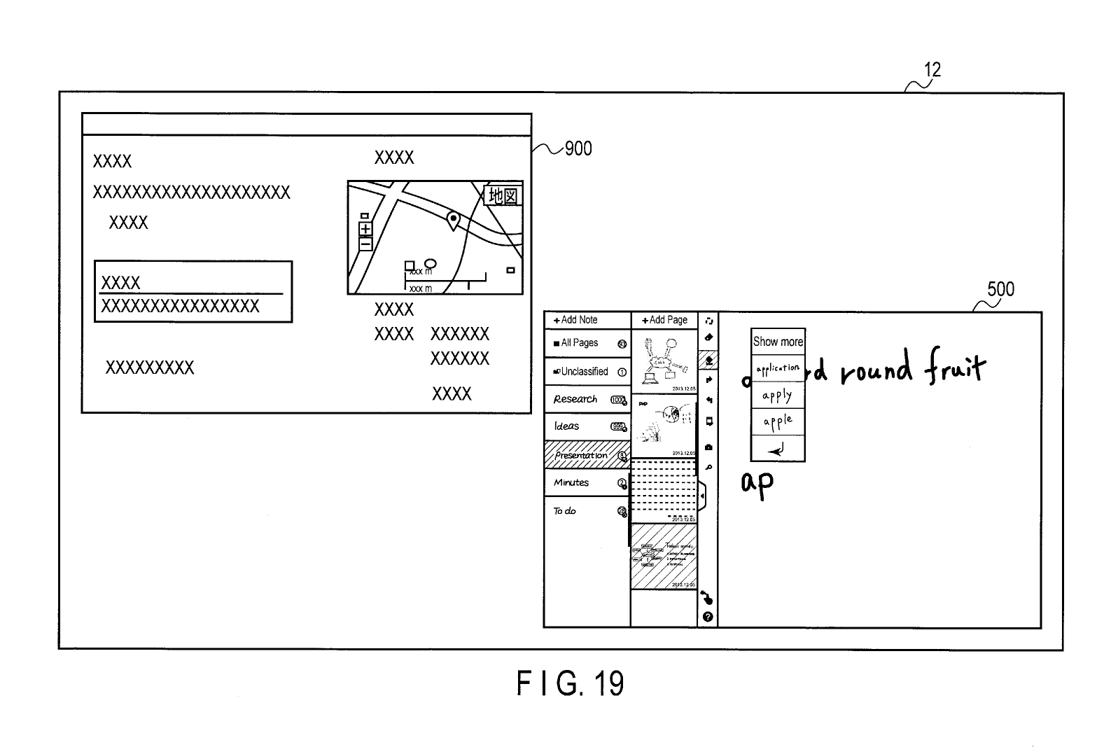

In the above explanations, the speech data input via the microphone 13 is used to acquire several handwriting candidates corresponding to the tentative strokes from the autocomplete dictionary database 402B. However, not only the speech data, but also various types of data can be used. For example, contents of a certain file are assumed to be viewed on an edit screen 500 of the handwritten notebook application program 202 and on the touchscreen display 12 by, for example, a viewer, as shown in FIG. 19 (display screen 900). In this case, the user may edit a page, i.e., handwrite a tentative stroke, on the edit screen 500 of the handwritten notebook application program 202, while referring to the file. Thus, the autocomplete processor 308A may use the data in the viewed file to acquire several handwriting candidates corresponding to the tentative stroke from the autocomplete dictionary database 402B. At this time, all data in the viewed file may be used or data to be displayed in the viewed file may be used. The viewed file may be, for example, not only a file in a state in which the display screen 900 of the viewer for displaying the file contents is opened on the touchscreen display 12, but also a file in a state in which the display screen 900 is minimized and hidden.

Each of various functions explained in the present embodiment may be implemented by a processing circuit. Examples of the processing circuit include a programmed processor such as a central processing unit (CPU). The processor executes each of the explained functions by executing the computer program (instruction group) stored in the memory. The processor may be a microprocessor comprising an electric circuit. Examples of the processing circuit include electric circuit components of a digital signal processor (DSP), application specific IC (ASIC), a microcomputer, a controller, etc. Each of the components other than CPU explained in the present embodiment may also be implemented by a processing circuit.

In addition, since various types of the processing of the present embodiment can be implemented by the computer program, the same advantages as those of the present embodiment can easily be obtained by installing the computer program in a computer via a computer-readable storage medium storing the computer program and by executing the computer program.

The CPU in the computer in which the computer program is installed can function as a processor configured to execute the above-explained handwriting autocomplete processing. The display controller in the computer can function as a display processor configured to display each stroke on the screen.

In addition, the example of using the tablet computer is explained in the present embodiment, but the handwritten document processing function of the present embodiment can also be applied to a general desktop PC. In this case, the tablet serving as the input device for handwriting input, etc., may be connected to the desktop PC.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiment described herein may be made without departing from the spirit of the invention. The accompanying claims and their equivalents are intended to cover such forms or modifications as would fall within the scope and spirit of the inventions.

What is claimed is:

1. An electronic device comprising:
a microphone that generates audio data based on sounds received therethrough;
a screen that detects a stroke input made on a surface thereof and displays the stroke;
a memory that stores different handwritings; and
a hardware processor configured to:
search handwritings for a first handwriting candidate and a second handwriting candidate in response to a handwritten stroke made on the surface;
determine whether a first character string of the first handwriting candidate or a second character string of the second handwriting candidate matches a third character string of a word contained in the audio data; and
display the first handwriting candidate at a first position and the second handwriting candidate at a second position on the screen,
wherein the second position is closer to an input position of the handwritten stroke on the surface than the first position, if the first character string does not match the third character string and the second character string matches the third character string.

2. The electronic device of claim 1, wherein the first position is closer to the input position of the handwritten stroke on the surface than the second position, if the first character string matches the third character string and the second character string does not match the third character string.

3. The electronic device of claim 1, further comprising:
a receiver configured to receive stroke data generated on another electronic device,
wherein the hardware processor displays the first handwriting candidate and the second handwriting candidate after receiving the stroke data.

4. The electronic device of claim 1, wherein the hardware processor is further configured to:
acquire a word included in a file being opened, and
select the first handwriting candidate and the second handwriting candidate among handwritings stored in the memory based on the word included in the file.

5. The electronic device of claim 1, wherein a character string of the handwritten stroke matches first N characters of the first and second character strings, where the number of characters in each of the first and second character strings is greater than N.

6. The electronic device of claim 1, wherein the word is contained in the audio data that is generated close in time to when the handwritten stroke is made on the surface of the screen.

7. The electronic device of claim 6, wherein the word is contained in the audio data that is generated prior to when the handwritten stroke is made on the surface of the screen.

8. A method of operating an electronic device, the method comprising:
generating stroke data representing a handwritten stroke made of a surface of a screen;
generating audio data representing audio received through a microphone; and
executing processing when the stroke data is generated, the processing including displaying the handwritten stroke and at least one handwriting candidate on the screen, the at least one handwriting candidate determined from plural handwritings based on the generated stroke data and the generated audio data.

9. The method of claim 8, wherein the at least one handwriting candidate determined from plural handwritings is also based on when the audio data was generated in comparison to when the stroke data was generated, such that the generated audio data that is closer in time to the generated stroke data is assigned a higher priority.

10. The method of claim 8, further comprising:
receiving stroke data generated on another electronic device,
wherein the at least one handwriting candidate is displayed after receiving the stroke data generated on another electronic device.

11. The method of claim 8, wherein the at least one handwriting candidate is determined from plural handwritings is also based on words in a file viewed on the screen.

12. The method of claim 8, wherein plural handwriting candidates are determined from plural handwritings and the plural handwriting candidates are displayed based on the generated audio data.

13. The method of claim 12, wherein the plural handwriting candidates include first and second handwriting candidates, and the first handwriting candidate is displayed closer to an input position of the handwritten stroke on the surface than the second handwriting candidate.

14. The method of claim 13, wherein each of the first and second handwriting candidates matches a word contained in the generated audio data, the word that matches the first handwriting candidate being spoken closer in time to when the handwritten stroke is made on the surface than the word that matches the second handwriting candidate.
